(19) United States
(12) Patent Application Publication
(10) Pub. No.: US 2010/0100677 A1
(43) Pub. Date: Apr. 22, 2010

(54) Power and performance management using MAIDx and adaptive data placement

(76) Inventors: Brian McKean, Longmont, CO (US); Ross Zwisler, Lafayette, CO (US)

Correspondence Address: LSI Corporation c/o Suiter Swantz pc llo, 14301 FNB Parkway, Suite 220, Omaha, NE, 68154, US

(21) Appl. No.: 12/288,037

(22) Filed: Oct. 16, 2008

(51) Int. Cl. G06F 12/02; G06F 12/00; G06F 12/16; G06F 13/00

(52) U.S. Cl. 711/114; 711/154; 711/162; 711/E12.001; 711/E12.103; 711/E12.002

(57) ABSTRACT

The present invention is a method for storing data. The method includes the step of dividing data into a plurality of uniformly-sized segments. The method further includes storing said uniformly-sized segments on a plurality of storage mechanisms. The method includes the steps of monitoring access to the uniformly-sized segments stored on the plurality of storage mechanisms to determine an access pattern; monitoring access patterns between the plurality of disks and monitoring performance characteristics of the plurality of storage mechanisms to determine a performance requirement for the plurality of storage mechanisms. Finally, the method includes the step of migrating at least one segment of the plurality of uniformly-sized segments from a first storage mechanism of the plurality of storage mechanisms to a second storage mechanism of the plurality of storage mechanisms in response to at least one of the access patterns or the performance requirements.

### FIELD OF THE INVENTION

The present invention relates to data storage apparatus for use in computer systems.

### BACKGROUND OF THE INVENTION

With increasing reliance on electronic means of data communication, different models to efficiently and economically store a large amount of data have been proposed. A data storage mechanism requires not only a sufficient amount of physical disk space to store data, but various levels of fault tolerance or redundancy (depending on how critical the data is) to preserve data integrity in the event of one or more disk failures.

One group of schemes for fault tolerant data storage includes the well-known RAID (Redundant Array of Independent Disks) levels or configurations. A number of RAID levels (e.g., RAID-0, RAID-1, RAID-3, RAID-4, RAID-5, etc.) are designed to provide fault tolerance and redundancy for different data storage applications. A data file in a RAID environment may be stored in any one of the RAID configurations depending on how critical the content of the data file is vis-à-vis how much physical disk space is affordable to provide redundancy or backup in the event of a disk failure. While the levels of fault tolerance or redundancy can be achieved by choosing the RAID configuration the economics of operation are less controllable.

An alternative means for storing large amounts of data is with the use of a MAID system. A MAID system is a massive array of idle disks. A MAID system uses hundreds to thousand of hard drives for near-line data storage. MAID was designed for Write Once, Read Occasionally (WORO) applications. In a MAID system each drive is only spun up on demand as needed to access the data stored on that drive. MAID systems benefit from storage density, and decreased cost, electrical power, and cooling requirements. However, this desirous economic benefit comes at the expense of latency, throughput, and redundancy.

Therefore, a need for balancing the economics of operation with the need for data access and reliability exists.

### SUMMARY OF THE INVENTION

Accordingly, an embodiment of the present invention is directed to a method for storing data, including dividing data into a plurality of uniformly-sized segments; storing said uniformly-sized segments on a plurality of storage mechanisms; monitoring access to the uniformly-sized segments stored on the plurality of storage mechanisms to determine an access pattern; monitoring access patterns between the plurality of disks; monitoring performance characteristics of the plurality of storage mechanisms to determine a performance requirement for the plurality of storage mechanisms; and migrating at least one segment of the plurality of uniformly-sized segments from a first storage mechanism of the plurality of storage mechanisms to a second storage mechanism of the plurality of storage mechanisms in response to at least one of the access patterns or the performance requirements.

A further embodiment of the present invention is directed to a mass storage system, including a processor, the processor configured for executing instructions; a plurality of storage devices, the plurality of storage devices connected to the processor and configured for storing a first data set in blocks sequentially across the plurality of storage devices and storing a second data set sequentially within at least one of the plurality of storage devices; and a controller, the controller operably connected to the plurality of storage devices configured for controlling the operation of the plurality of storage devices; wherein the plurality of storage devices are not all powered on at the same time.

An additional embodiment of the present invention is directed to a method for storing data, including dividing data into a plurality of uniformly-sized segments; storing said uniformly-sized segments on a plurality of storage mechanisms; monitoring access to the uniformly-sized segments stored on the plurality of storage mechanisms to determine an access pattern; monitoring access patterns between the plurality of disks; monitoring performance characteristics of the plurality of storage mechanisms to determine a performance requirement for the plurality of storage mechanisms; migrating at least one segment of the plurality of uniformly-sized segments from a first storage mechanism of the plurality of storage mechanisms to a second storage mechanism of the plurality of storage mechanisms in response to at least one of the access patterns or the performance requirements; identifying a reserve capacity on at least one of the plurality of storage mechanisms; implementing a working copy of at least one of the uniformly-sized segments onto at least one of the said plurality of storage mechanisms identified as having a reserve capacity; storing the working copy of the at least one of the uniformly-sized segments on the at least one of the said plurality of storage mechanisms where said at least one of the plurality of storage mechanisms is accessible; and discarding said working copy of the at least one of the uniformly-sized segments on the at least one of the said plurality of storage mechanisms where said at least one of the plurality of storage mechanisms is powered on and updated with a current uniformly-sized segment.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a flow diagram illustrating a methodology for storing data in a massive array of idle disks;

FIG. 2 is a flow diagram illustrating a methodology for storing data in a massive array of idle disks; and

FIG. 3 is a block diagram illustrating a system for storing data in a massive array of idle disks.

### DETAILED DESCRIPTION OF THE INVENTION

Reference will now be made in detail to the presently preferred embodiments of the present invention, examples of which are illustrated in the accompanying drawings.

The present disclosure is described below with reference to flowchart illustrations of methods. It will be understood that each block of the flowchart illustrations and/or combinations of blocks in the flowchart illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart. These computer program instructions may also be stored in a computer-readable tangible medium (thus comprising a computer program product) that can direct a computer or other programmable data processing apparatus to function in a particular manner, such that the instructions stored in the computer-readable tangible medium produce an article of manufacture including instruction means which implement the function/act specified in the flowchart.

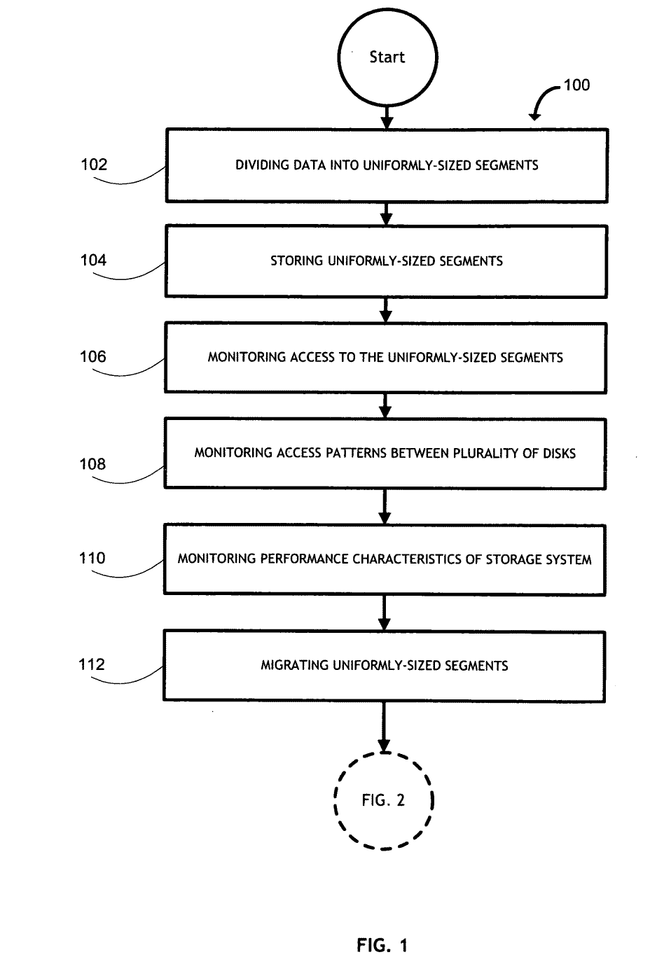

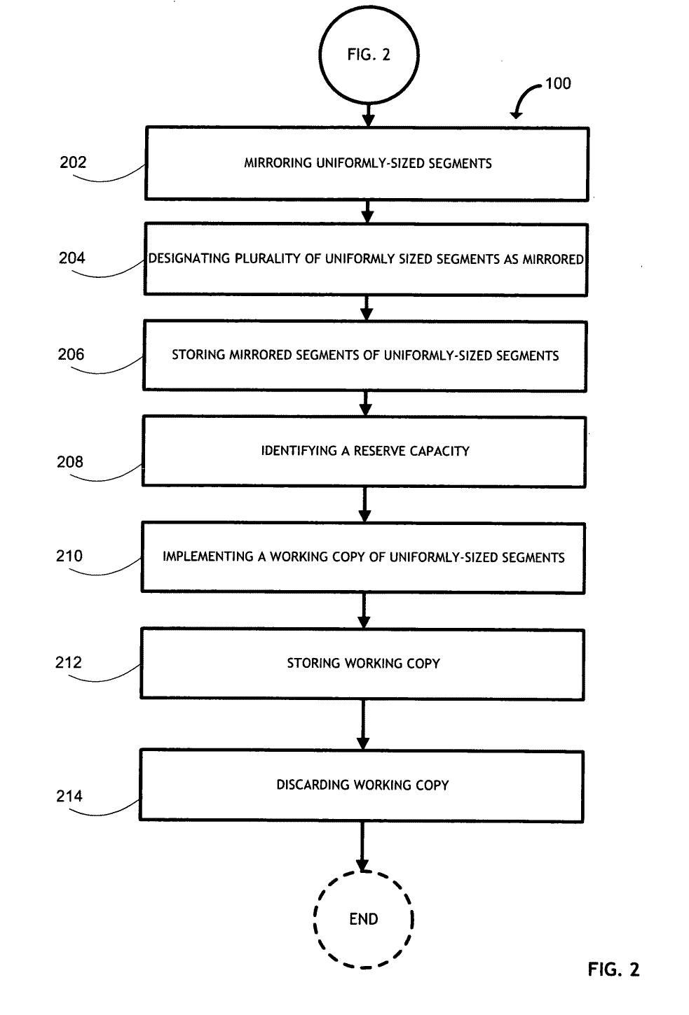

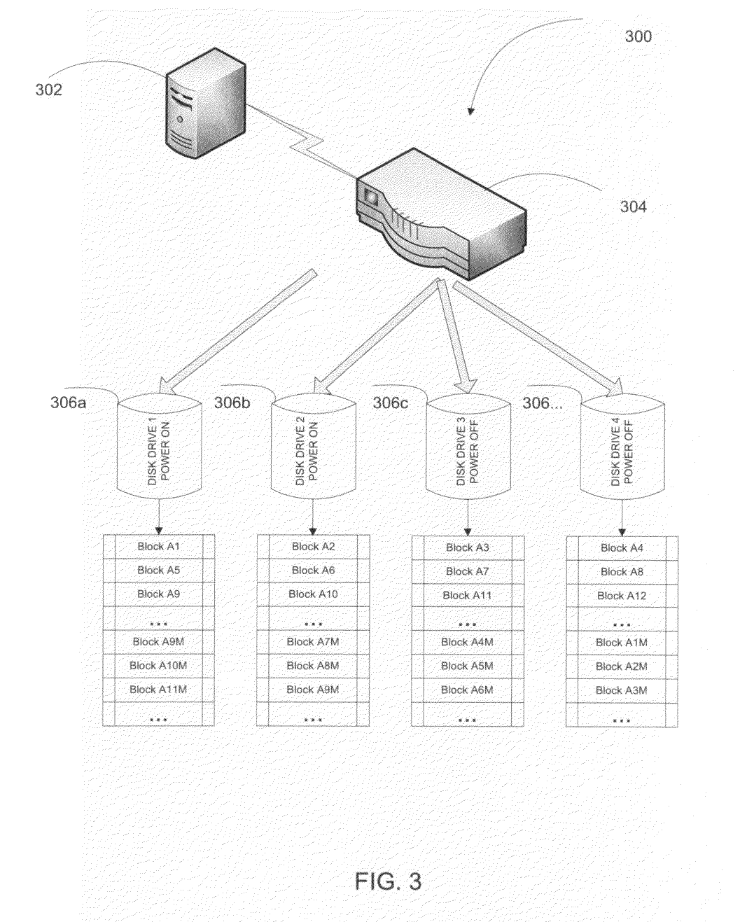

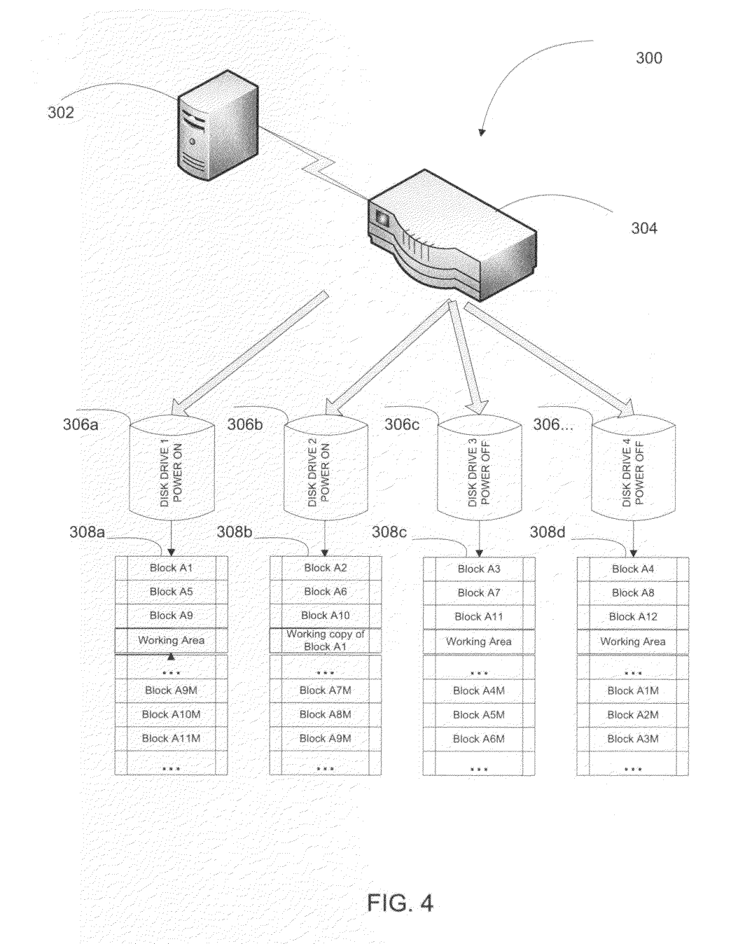

Referring generally to FIG. 1-3 a method and system for managing power and performance of mass data storage is shown.

FIG. 1 is a flow chart illustrating a data storage methodology in accordance with an exemplary embodiment of the present invention. The method 100 may include the step of dividing data 102 into a plurality of uniformly-sized segments. For example, as the volume of data is received it may be broken into 1 MB data chunks, each of the data chunks may be distributed among a plurality of storage mechanisms. While 1 MB uniformly-sized data chunks are described herein, other sizes may be implemented where uniformity is maintained. This uniformity allows for the movement and replacement of data chunks according to need and power management concerns.

Method 100 may include step 104, store each of the uniformly sized data chunks sequentially across the disks. For example, host sends data to be written to and distributed over storage mechanisms. A primary copy of the data chunks may be sequentially stored across all drives in a MAID system. A secondary copy of the data chunks may be arranged and stored sequentially within a disk. Further, the plurality of storage mechanisms may include a first set of storage mechanisms exhibiting always on characteristics and a second set of storage mechanisms exhibiting inactive except when accessed characteristics.

Method 100 may include step 106, monitoring access to the uniformly-sized data segments. For example, an access protocol is set for accessing the uniformly-sized segments on at least one of the said plurality of storage mechanisms and determining access topography for the uniformly-sized segments in accordance with the access protocol.

Method 100 may include step 108, monitoring access patterns between a plurality of disks. For example, as the data segments are accessed a monitoring process identifies any access patterns present.

Method 100 may include step 110, monitoring performance characteristics of storage system. For example, a performance specification is set for the plurality of storage mechanisms and performance topography is determined to achieve the performance specification as set for the plurality of storage mechanisms.

Method 100 may include step 112, migrating uniformly-sized segments. For example, through the monitoring process data may be moved from one disk location to another disk location in order reduce power consumption while ensuring data redundancy and reducing latency. Moreover, the data is migrated in order to localize the data being accessed to the fewest storage mechanisms that meet redundancy and performance requirements. Further, the first storage mechanism and the second storage mechanism may be assigned to the first and second sets of storage mechanisms in accordance with a storage topography.

Method 100 may include the step of mirroring 202 the plurality of uniformly-sized segments while designating 204 said plurality of uniformly-sized segments as mirrored segments of the plurality of uniformly-sized segments and the step of storing 206 said mirrored segments of uniformly-sized segments on a plurality of storage mechanisms. For example, where the data is divided into 1 MB uniformly-sized segments each segment is mirrored and stored on the plurality of disks sequentially within each disk.

Method 100 may further include the step of identifying 208 a reserve capacity on at least one of a plurality of storage mechanisms. Further, the step of implementing 210 a working copy of at least one of the uniformly-sized segments onto at Least one of the said plurality of storage mechanisms identified as having a reserve capacity.

Method 100 may further include the step of storing 212 a working copy of the uniformly-sized segments on the at least one of the said plurality of storage mechanisms where said at least one of the plurality of storage mechanisms is accessible. Further, method 100 may include the step 214 of discarding the working copy of the at least one of the uniformly-sized segment on at least one of the said plurality of storage mechanisms where said at least one of the plurality of storage mechanisms is powered on and updated with a current uniformly-sized segment.

In a further embodiment of the present disclosure a system 300 for storing data in accordance with an exemplary embodiment of the present disclosure is shown. The system 300 may include a processor 302. The processor 302 may be configured for executing instructions. For example, the processor may be configured for preparing/dividing the data units into 1 MB chunks.

System 300 may include a plurality of storage mechanisms 304. The storage devices 304 may be connected to the processor and configured for storing a first data set in blocks sequentially across the plurality of storage devices and storing a second data set sequentially within at least one of the plurality of storage devices 304. In the present system 300, the plurality of storage devices 304 may not all be powered on and spinning at the same time, however, where a request for access to stored data is received at least one of the plurality of storage devices 304 will be spun up in response if said device is idle at the time of the request.

System 300 may include a controller 306. The controller 306 may be operably connected to the plurality of storage devices configured for controlling the operation of the plurality of storage devices. For example, the controller 306 may be configured for monitoring access patterns to the data stored on the plurality of storage devices 304. Further, the controller 306 may be configured for monitoring performance characteristics of the plurality of storage devices. And further yet, the controller 306 may be configured for moving data via migration in response to access patterns and performance requirements.

System 300 may include a data storage layout 308. The data storage layout 308 may be configured for storing a working copy of at a least one data set in a reserved capacity on at least one of the plurality of storage devices 304 and discarding the working copy where the at Least one data set corresponding to the working copy is updated.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for storing data, comprising:
dividing data into a plurality of uniformly-sized segments;
storing said uniformly-sized segments on a plurality of storage mechanisms, the plurality of storage mechanisms comprising: a first set of storage mechanisms exhibiting always on characteristics and a second set of storage mechanisms exhibiting inactive except when accessed characteristics;
monitoring access to the uniformly-sized segments stored on the plurality of storage mechanisms to determine an access pattern;
monitoring access patterns between the plurality of disks;
monitoring performance characteristics of the plurality of storage mechanisms to determine a performance requirement for the plurality of storage mechanisms; and
migrating at least one segment of the plurality of uniformly-sized segments from a first storage mechanism of the first set of storage mechanisms to a second storage mechanism of the second set of storage mechanisms in response to at least one of the access patterns or the performance requirements, the first storage mechanism and the second storage mechanism being assigned to the first and second sets of storage mechanisms in accordance with a storage topography.

2. The method of claim 1, further comprising:
mirroring the plurality of uniformly-sized segments;
designating said plurality of uniformly-sized segments as mirrored segments of the plurality of uniformly-sized segments; and
storing said mirrored segments of uniformly-sized segments on a plurality of storage mechanisms.

3. The method of claim 1, further comprising:
identifying a reserve capacity on at Least one of the plurality of storage mechanisms;
implementing a working copy of at least one of the uniformly-sized segments onto at Least one of the said plurality of storage mechanisms identified as having a reserve capacity;
storing the working copy of the at Least one of the uniformly-sized segments on the at least one of the said plurality of storage mechanisms where said at least one of the plurality of storage mechanisms is accessible;
discarding said working copy of the at least one of the uniformly-sized segments on the at Least one of the said plurality of storage mechanisms where said at Least one of the plurality of storage mechanisms is powered on and updated with a current uniformly-sized segment.

4. The method of claim 1, wherein dividing data into a plurality of uniformly-sized segments comprises:
breaking each volume into 1 MB chunks of data.

5. The method of claim 1, wherein storing said uniformly-sized segments on a plurality of storage mechanisms comprises:
storing said uniformly-sized segments on a massive array of idle disks.

6. The method of claim 1, wherein storing said uniformly-sized segments on a plurality of storage mechanisms comprises:
storing said uniformly-sized segments on a redundant array of inexpensive disks.

7. The method of claim 1, wherein monitoring access to the uniformly-sized segments stored on the plurality of storage mechanisms to determine an access pattern comprises:
setting an access protocol for accessing the uniformly-sized segments on the at Least one of the said plurality of storage mechanisms and determining an access topography for the uniformly-sized segments in accordance with the access protocol.

8. The method of claim 1, wherein monitoring performance characteristics of the plurality of storage mechanisms to determine a performance requirement for the plurality of storage mechanisms comprises:
setting a performance specification for the plurality of storage mechanisms and determining a performance topography to achieve the performance specification set for the plurality of storage mechanisms.

9. The method of claim 1, wherein migrating at least one segment of the plurality of uniformly-sized segments from a first storage mechanism of the plurality of storage mechanisms in response to at least on of the access pattern or the performance requirements comprises:
migrating data in order to localize the data being accessed to the fewest storage mechanisms that meet redundancy and performance requirements.

10. A mass storage system, comprising:
a processor, the processor configured for executing instructions;
a plurality of storage devices, the plurality of storage devices connected to the processor and configured for storing a first data set in blocks sequentially across the plurality of storage devices and storing a second data set sequentially within at least one of the plurality of storage devices; and
a controller, the controller operably connected to the plurality of storage devices configured for controlling the operation of the plurality of storage devices;
wherein the plurality of storage devices comprise a first set of storage mechanisms exhibiting always on characteristics and a second set of storage mechanisms exhibiting inactive except when accessed characteristics.

11. The mass storage system as claimed in claim 10 further comprises:
a data storage layout configured for storing a working copy of at least one data set in a reserved capacity on at least one of the plurality of storage devices and discarding the working copy where the at least one data set corresponding to the working copy is updated.

12. The mass storage system as claimed in claim 10, wherein the processor prepares data units in 1 MB chunks.

13. The mass storage system as claimed in claim 10, wherein the controller monitors access patterns to data stored on the plurality of storage devices.

14. The mass storage system as claimed in claim 10, wherein the controller monitors performance characteristics of the plurality of storage devices.

15. The mass storage system as claimed in claim 10, wherein the controller moves data via migration in response to access patterns and performance requirements.

16. The mass storage system as claimed in claim 10, wherein at least one of the plurality of storage devices is spun up where a request for access is received.

17. A method for storing data, comprising:
dividing data into a plurality of uniformly-sized segments;
storing said uniformly-sized segments on a plurality of storage mechanisms;
monitoring access to the uniformly-sized segments stored on the plurality of storage mechanisms to determine an access pattern;
monitoring access patterns between the plurality of disks;
monitoring performance characteristics of the plurality of storage mechanisms to determine a performance requirement for the plurality of storage mechanisms;
migrating at least one segment of the plurality of uniformly-sized segments from a first storage mechanism of the plurality of storage mechanisms to a second storage mechanism of the plurality of storage mechanisms in response to at least one of the access patterns or the performance requirements;
identifying a reserve capacity on at least one of the plurality of storage mechanisms;
implementing a working copy of at Least one of the uniformly-sized segments onto at least one of the said plurality of storage mechanisms identified as having a reserve capacity;
storing the working copy of the at least one of the uniformly-sized segments on the at least one of the said plurality of storage mechanisms where said at Least one of the plurality of storage mechanisms is accessible; and
discarding said working copy of the at least one of the uniformly-sized segments on the at least one of the said plurality of storage mechanisms where said at least one of the plurality of storage mechanisms is powered on and updated with a current uniformly-sized segment.
